(19) United States
(12) Patent Application Publication
(10) Pub. No.: US 2013/0007517 A1
(43) Pub. Date: Jan. 3, 2013

(54) Checkpoint Recovery Utility for Programs and Compilers

(75) Inventors: James P. Eberwein, Raleigh, NC (US); Erik A. Kirk, Katy, TX (US)

(73) Assignee: INTERNATIONAL BUSINESS MACHINES CORPORATION, Armonk, NY (US)

(21) Appl. No.: 13/173,241

(22) Filed: Jun. 30, 2011

(51) Int. Cl. G06F 11/34

(52) U.S. Cl. 714/15; 714/E11.189

(57) ABSTRACT

Systems and methods may provide for conducting a recursive dependency analysis of an application file to identify a set of original libraries associated with the application file, and creating a set of interceptor libraries based on the set of original libraries. In addition, an execution environment may be prepared to support the execution of the interceptor libraries in conjunction with the execution of the original libraries, and the application file may be executed. Moreover, one or more execution characteristics of the interceptor libraries can be recorded and output via a utility interface.

### BACKGROUND

Embodiments of the present invention generally relate to checkpoint recovery systems. More particularly, embodiments relate to a utility interface that enables enhanced checkpoint recovery operations.

When software applications experience problems, there may be overhead costs associated with recreating and investigating the problems in the absence of proper documentation, particularly when doing so on other computing platforms. Moreover, intermittent problems can lead to multiple instances of unwanted exposure while waiting for a reoccurrence of the problem. While certain checkpoint recovery solutions may provide for resuming execution of an application from the point of a restored state, there remains considerable room for improvement.

### BRIEF SUMMARY

Embodiments may include a computer program product having a computer readable storage medium and computer usable code stored on the computer readable storage medium. If executed by a processor, the computer usable code may execute an application file having a corresponding set of interceptor libraries, and record one or more execution characteristics of the set of interceptor libraries. The computer usable code may also output the one or more execution characteristics via a utility interface.

Embodiments may also involve a computer implemented method in which a recursive dependency analysis is conducted to identify a set of original libraries associated with the application file, wherein the application file includes at least one of an executable file and a library. In one example, the recursive dependency analysis is exhaustive with respect to the application file. The method can also provide for creating a set of interceptor libraries based on the set of original libraries, and preparing an execution environment to support an execution of the set of interceptor libraries in conjunction with an execution of the set of original libraries. The application file may be executed, and one or more execution characteristics of the set of interceptor libraries may be recorded. In addition, the method may involve outputting the one or more execution characteristics via a utility interface, and receiving user input via the utility interface. At least one of the one or more execution characteristics can be modified based on the user input, and the application file may be re-executed.

Other embodiments may include a computer program product having a computer readable storage medium and computer usable code stored on the computer readable storage medium. If executed by a processor, the computer usable code may conduct a recursive dependency analysis of an application file to identify a set of original libraries associated with the application file, wherein the application file is to include at least one of an executable file and a library. The recursive dependency analysis can be exhaustive with respect to the application file. The computer usable code may also create a set of interceptor libraries based on the set of original libraries, and prepare an execution environment to support an execution of the set of interceptor libraries in conjunction with an execution of the set of original libraries. In addition, the computer usable code can execute the application file, record one or more execution characteristics of the set of interceptor libraries, output the one or more execution characteristics via a utility interface, and receive user input via the utility interface. The computer usable code can also modify at least one of the one or more execution characteristics based on the user input, and re-execute the application file.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of an example of a scheme of creating interceptor libraries according to an embodiment;

FIG. 2 is a flowchart of an example of a method of initializing an application file according to an embodiment;

FIG. 3 is a flowchart of an example of a method of troubleshooting an application file according to an embodiment;

FIG. 4 is a block diagram of an example of a checkpoint recovery utility according to an embodiment; and

FIG. 5 is a block diagram of an example of a computing system according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

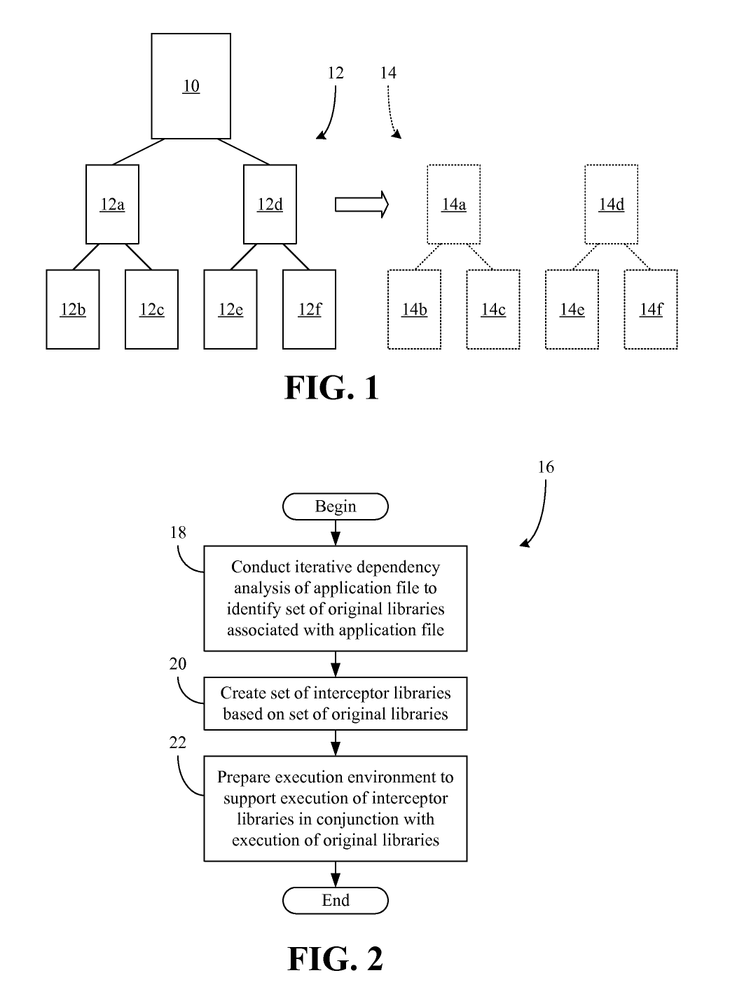

Referring now to FIG. 1, an application file 10 with a set of original libraries 12 (12a-12f) is shown, wherein the application file 10 itself may be an executable file, a library, and so forth. Thus, the application file 10 may contain executable machine code that has resulted from compiling source code written in one or more programming languages (e.g., “C”, Java, Smalltalk). In the illustrated example, a recursive dependency analysis is conducted on the application file 10 to identify each library in the set of original libraries 12, which can include one or more libraries used in the execution of the application file 10. In one example, the set of original libraries 12 includes a relatively high number of libraries. The recursive dependency analysis may be conducted by a utility (not shown) having computer usable code to recognize one or more programming languages used to generate the application file 10, reverse compile the application file 10 based on knowledge of the appropriate languages, and identify one or more method calls made in the reverse compiled file (e.g., based on header information of the original libraries). The method calls could be internal calls or external calls, wherein the utility is also able to identify any arguments (e.g., values, information, data, parameters, etc.) passed in the calls.

In the illustrated example, the application file 10 makes an external call to a library 12a and a library 12d. Accordingly, the libraries 12a, 12d may be considered “dependencies” from the perspective of the application file 10. The utility may therefore in turn read each library 12a, 12d to determine its dependencies. For example, the utility might determine that the library 12a makes external calls to libraries 12b and 12c, whereas the library 12d makes external calls to libraries 12e and 12f. The recursive dependency analysis may continue until the all dependencies have been found and may therefore be considered exhaustive with respect to the application file 10.

As will be discussed in greater detail, the utility can use the set of original libraries 12 to create a set of interceptor libraries 14 (14a-14f), wherein the set of interceptor libraries 14 may enable the utility to record execution characteristics such as method calls made and arguments passed during execution of the application file 10. In particular, the set of original libraries 14 can function as intermediary files that enable the state of execution to be tracked without modifying the application file 10 or any of the original libraries 14.

FIG. 2 shows a method 16 of initializing an application file such as the application file 10 (FIG. 1) or a library for checkpoint recovery and/or debugging purposes. The method 16 may be implemented in a utility as computer usable code which, if executed by a processor, causes a computer to conduct the illustrated processing blocks. For example, processing block 18 provides for conducting a recursive dependency analysis of the application file to identify a set of original libraries associated with the application file, wherein the analysis can be exhaustive with respect to the application file, as already discussed. A set of interceptor libraries may be created at block 20 based on the set of original libraries, and block 22 provides for preparing an execution environment to support an execution of the set of interceptor libraries in conjunction with an execution of the set of original libraries. In particular, the environment may be structured so that the interceptor libraries intercept calls intended for the original libraries, record various aspects of the calls (e.g., execution characteristics), and pass the calls along to the original libraries for normal processing.

The environment preparation process may be conducted in a variety of ways. For example, one approach can be to rename the files in the set of original libraries and assign the original file names to the corresponding interceptor libraries. Thus, in the example above, original library 12a (FIG. 1) might be given a new name and interceptor library 14a (FIG. 1) could be given the previous name of the original library 12a (FIG. 1). By tracking the former name of each original library, its new name, and the location of the library, such an approach can obviate any need to change environment variables. Another approach may be to create a new directory structure that contains the original libraries and the interceptor libraries, and modify the appropriate environment variables to redirect the operating system (OS) to the new directory structure. Other approaches may also be used to prepare the execution environment.

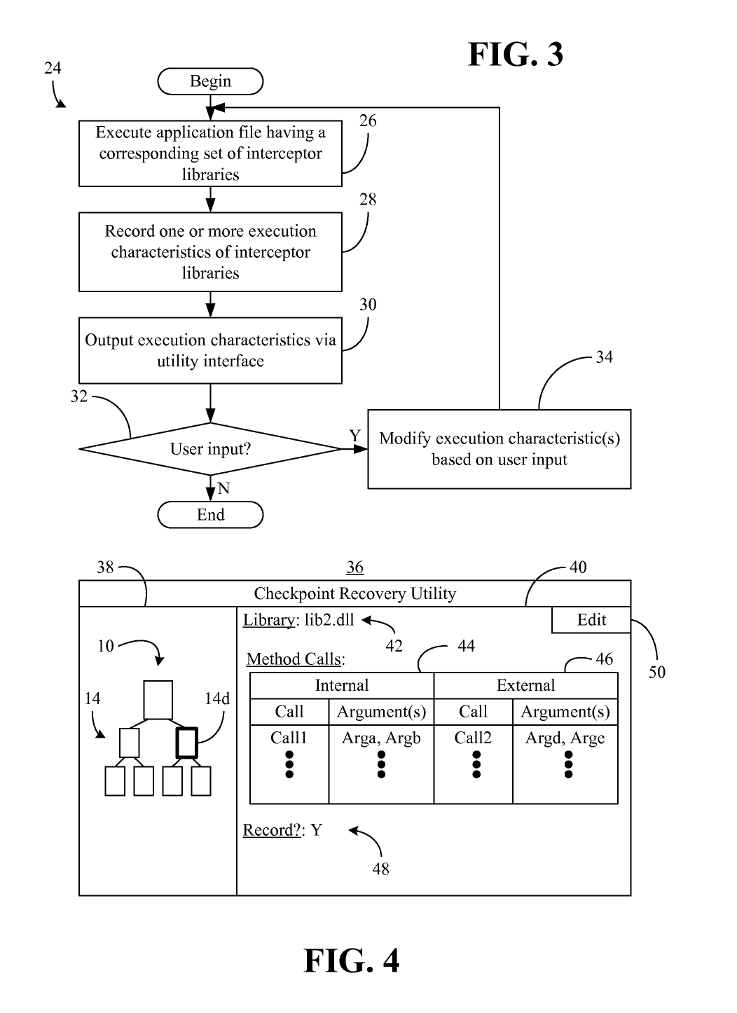

Turning now to FIG. 3, a method 24 of troubleshooting an application file is shown. The method 24 may also be implemented in computer usable code of a utility. Processing block 26 provides for executing an application file having a corresponding set of interceptor libraries, wherein one or more execution characteristics of the interceptor libraries may be recorded at block 28. As already noted, the execution characteristics may include, but are not limited to, internal calls, external calls, the arguments passed with such calls, and so forth. Illustrated block 30 outputs the recorded execution characteristics, as well as other pertinent information, via a utility interface. If user input is received at block 32, one or more of the execution characteristics may be modified at block 34 based on the user input, and the application file may be re-executed. Thus, the utility interface can enable users to debug/troubleshoot the application file in addition to restore the system to a previous operational state.

FIG. 4 shows a utility interface 36 in which a user is presented with the ability to view, monitor and/or modify the interceptor libraries associated with a particular application file. In the illustrated example, a left panel 38 includes high-level information such as a hierarchical depiction of the application file 10 and its associated interceptor libraries 12, wherein a user has selected a particular interceptor library such as interceptor library 14d for further analysis. The selection has resulted in the display of the detail of the interceptor library 14d in a main panel 40. In particular, the main panel 40 might include information such as the library name 42, which may also include the library location (e.g., file path) and/or corresponding original library file name. The illustrated main panel 40 also includes an internal call detail section 44 and an external call detail section 46, wherein the sections 44, 46 include the specifics of the method calls made by the interceptor library 14d as well as any arguments (e.g., values, information, data, parameters, etc.) passed by the calls. For example, one or more of the external call entries may identify other libraries. The main panel 40 may also include an indication 48 as to whether the interceptor library 14d is set to record execution characteristics or merely pass information through to its corresponding original library 12d (FIG. 1).

In addition, an edit button 50 enables the user to modify any of the detail information shown. For example, an internal method call (e.g., “Call1”) could be changed to a different method call, or one of the external call arguments (e.g., “Argd”) may be changed to a different value. In such a case, re-executing the application file 10 may enable the user to debug/troubleshoot the application file 10 without making any substantive changes to the application file 10 or its associated original libraries 12 (FIG. 1). Moreover, the arguments passed may be used to conduct other activities such as memory address lookups that could enable the utility to capture actual data being pointed to, review the data passed in, and possibly modify the data in order to test a workaround to the problem being solved. For example, if a negative integer is suspected to be causing an issue, the interceptor library 14d could be used to change the negative integer to a positive value, as well as to document the original value, the new value, and the fact that the change was made.

Other example uses of the utility interface 36 include, but are not limited to, making trace entries and determining where trace entries and other logging entries are made. Indeed, it may be useful to separate some of the data into different locations so that core application files write to one location, while other external libraries are directed to write to another location. It may also be useful to store checkpoint recovery information separately from traces, wherein the utility interface 36 can be used to modify the data storage aspects of the individual interceptor libraries 14.

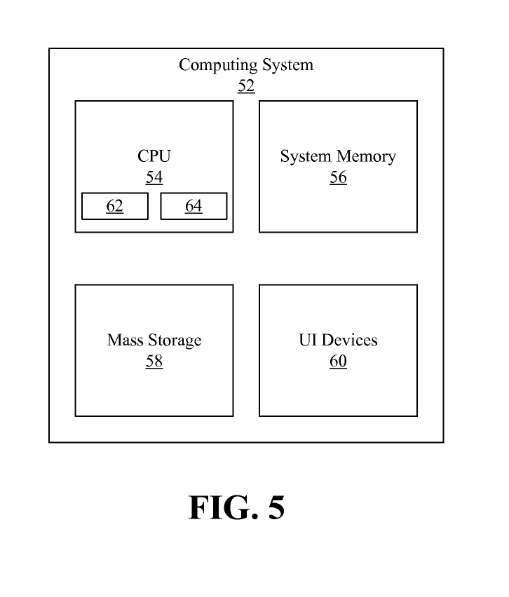

FIG. 5 shows a computing system 52 having a central processing unit (CPU) 54, system memory (e.g., dynamic random access memory/DRAM) 56, mass storage (e.g., hard disk drive/HDD, optical disk, programmable read only memory/PROM, flash memory) 58 and various user interface (UI) devices (e.g, display, keyboard, mouse, microphone) 60. The illustrated CPU 54 executes a utility 62 that is configured to initialize, monitor and troubleshoot an application file 64. In particular, the utility 62 may identify a set of original libraries associated with the application file 64, create a set of interceptor libraries based on the set of original libraries, prepare an execution environment to support the execution of the interceptor libraries in conjunction with the execution of the original libraries, execute the application file, record one or more execution characteristics of the interceptor libraries, and output the execution characteristics via a utility interface such as the utility interface 36 (FIG. 4), as already discussed. In addition, a user may interact with the UI devices 60 to provide user input to the utility interface, wherein the utility 62 can modify one or more of the execution characteristics based on the user input and re-execute the application file 64.

Thus, the illustrated utility 62 can easily implement checkpoint recovery, extra logging, tracing, and/or other debugging features without modifying the environment or the original source code. Accordingly, the utility 62 can be used to eliminate the need to manually embed trace functionality within the original source code of an application file. Moreover, for those applications which have insufficient tracing functionality, the utility 62 may be used to establish any level of logging without modifying the original source code. Additionally, the resulting interceptor libraries can record the information necessary to allow for checkpoint recovery.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. are used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer implemented method comprising:
conducting a recursive dependency analysis of an application file to identify a set of original libraries associated with the application file, wherein the application file includes at least one of an executable file and a library, and the recursive dependency analysis is exhaustive with respect to the application file;
creating a set of interceptor libraries based on the set of original libraries;
preparing an execution environment to support an execution of the set of interceptor libraries in conjunction with an execution of the set of original libraries;
executing the application file;
recording one or more execution characteristics of the set of interceptor libraries;
outputting the one or more execution characteristics via a utility interface;
receiving user input via the utility interface;
modifying at least one of the one or more execution characteristics based on the user input; and
re-executing the application file.

2. The method of claim 1, wherein preparing the execution environment includes:
renaming one or more files in the set of original libraries; and
tracking one or more original file names and associated new file names resulting from renaming the one or more files in the set of original libraries.

3. The method of claim 1, wherein preparing the execution environment includes:
creating a new directory structure that contains the set of original libraries and the set of interceptor libraries; and
modifying one or more environment variables to redirect an operating system to the new directory structure.

4. The method of claim 1, wherein recording the one or more execution characteristics includes recording one or more calls made by the interceptor libraries, wherein the calls include at least one of an internal call and an external call.

5. The method of claim 1, wherein recording the one or more execution characteristics includes recording one or more arguments passed by the set of interceptor libraries.

6. A computer program product comprising:
a computer readable storage medium; and
computer usable code stored on the computer readable storage medium, where, if executed by a processor, the computer usable code causes a computer to:
conduct a recursive dependency analysis of an application file to identify a set of original libraries associated with the application file, wherein the application file is to include at least one of an executable file and a library, and the recursive dependency analysis is to be exhaustive with respect to the application file,
create a set of interceptor libraries based on the set of original libraries,
prepare an execution environment to support an execution of the set of interceptor libraries in conjunction with an execution of the set of original libraries,
execute the application file,
record one or more execution characteristics of the set of interceptor libraries,
output the one or more execution characteristics via a utility interface,
receive user input via the utility interface,
modify at least one of the one or more execution characteristics based on the user input, and
re-execute the application file.

7. The computer program product of claim 6, wherein the computer usable code, if executed, causes a computer to:
rename one or more files in the set of original libraries, and
track one or more original file names and associated new file names resulting from renaming the one or more files in the set of original libraries.

8. The computer program product of claim 6, wherein the computer usable code, if executed, causes a computer to:
create a new directory structure that contains the set of original libraries and the set of interceptor libraries, and
modify one or more environment variables to redirect an operating system to the new directory structure.

9. The computer program product of claim 6, wherein the computer usable code, if executed, causes a computer to record one or more calls made by the interceptor libraries, wherein the calls include at least one of an internal call and an external call.

10. The computer program product of claim 6, wherein the computer usable code, if executed, causes a computer to record one or more arguments passed by the set of interceptor libraries.

11. A computer program product comprising:
a computer readable storage medium; and
computer usable code stored on the computer readable storage medium, where, if executed by a processor, the computer usable code causes a computer to:
execute an application file having a corresponding set of interceptor libraries,
record one or more execution characteristics of the set of interceptor libraries, and
output the one or more execution characteristics via a utility interface.

12. The computer program product of claim 11, wherein, if executed, the computer usable code causes a computer to:
identify a set of original libraries associated with the application file,
create the set of interceptor libraries based on the set of original libraries, and
prepare an execution environment to support an execution of the set of interceptor libraries in conjunction with an execution of the set of original libraries.

13. The computer program product of claim 12, wherein, if executed, the computer usable code causes a computer to conduct a recursive dependency analysis to identify the set of original libraries.

14. The computer program product of claim 13, wherein the recursive dependency analysis is to be exhaustive with respect to the application file.

15. The computer program product of claim 12, wherein, if executed, the computer usable code causes a computer to:
rename one or more files in the set of original libraries, and
track one or more original file names and associated new file names resulting from renaming the one or more files in the set of original libraries.

16. The computer program product of claim 12, wherein, if executed, the computer usable code causes a computer to:
create a new directory structure that contains the set of original libraries and the set of interceptor libraries, and
modify one or more environment variables to redirect an operating system to the new directory structure.

17. The computer program product of claim 11, wherein the application file is to include at least one of an executable file and a library.

18. The computer program product of claim 11, wherein the computer usable code, if executed, causes a computer to record one or more calls made by the set of interceptor libraries, wherein the calls are to include at least one of an internal call and an external call.

19. The computer program product of claim 11, wherein the computer usable code, if executed, causes a computer to record one or more arguments passed by the set of interceptor libraries.

20. The computer program product of claim 11, wherein the computer usable code, if executed, causes a computer to:
receive user input via the utility interface,
modify at least one of the one or more execution characteristics based on the user input, and
re-execute the application file.
